(19) United States
(12) Patent Application Publication
(10) Pub. No.: US 2007/0098326 A1
(43) Pub. Date: May 3, 2007

(54) Light guide screen with louver device

(76) Inventors: Huei Pei Kuo, Palo Alto, CA (US); Lawrence M. Hubby JR., Palo Alto, CA (US); Steven L. Naberhuis, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/264,203

(22) Filed: Nov. 1, 2005

(51) Int. Cl. G02B 6/26; G02B 6/40

(52) U.S. Cl. 385/50; 385/52; 385/54

(57) ABSTRACT

Provided is a light guide screen with louver device. An input group consists of a plurality of aligned light guides arranged into light guide layers, the output ends of each light guide interfacing with an input surface of the louver device. An output surface of the louver device interfaces with the input ends of a second plurality of light guides, arranged into light guide layers to form an output group. The louver device is positioned between the input group and the output group. The louver device includes one or more louver members to direct light from the input group, through the output group, and toward a output face. The louver members may be rectangular, elliptical, cylindrical, or other geometric shapes, and may be mirrored or coated with a reflective coating.

### RELATED APPLICATIONS

This application is related to commonly owned U.S. patent application Ser. No. 10/698,829, filed on Oct. 31, 2003 by inventors Huei Pei Kuo, Lawrence M. Hubby, Jr. and Steven L. Naberhuis and entitled “Light Guide Apparatus For Use In Rear Projection Display Environments”, herein incorporated by reference. Further, this application is related to commonly owned U.S. patent application Ser. No. TBD, filed on TBD by inventors Huei Pei Kuo, Lawrence M. Hubby, Jr. and Steven L. Naberhuis and entitled “Holographic Louver Device for a Light Guide Screen”, herein incorporated by reference.

### FIELD

This invention relates generally to the field of display devices, and more particularly to a light guide screen with a louver device.

### BACKGROUND

Socially and professionally, most people rely upon video displays in one form or another for at least a portion of their work and/or recreation. With a growing demand for large screens, such as high definition television (HDTV), cathode ray tubes (CRTs) have largely given way to displays composed of liquid crystal devices (LCDs), plasma display panels (PDPs), or front or rear projection systems.

A CRT operates by scanning electron beam(s) that excite phosphor materials on the back side of a transparent screen, wherein the intensity of each pixel is commonly tied to the intensity of the electron beam. With a PDP, each pixel is an individual light-emitting device capable of generating its own light. With an LCD, each pixel is a back-lit, light modulating liquid crystal device.

As neither system utilizes a large tube, LCD and PDP screens may be quite thin and often are lighter than comparable CRT displays. However, the manufacturing process for LCDs, PDPs and most other flat panel displays is much more complex and intensive with respect to both equipment and materials than that of CRTs, typically resulting in higher selling prices.

Projection systems offer alternatives to PDP and LCD based systems. In many cases, projection display systems are less expensive than comparably sized PDP or LCD display systems. Rear projection display systems typically employ a wide angle projection lens (or multiple lenses), operating in connection with one or more reflective surfaces to direct light received from the projector through the lens(es) to the back of a screen. The lens and mirror arrangement typically enlarges the image as well.

To accommodate the projector, one or more lenses, and reflectors, rear projection displays are typically 18 to 20 inches deep and not suitable for on-wall mounting. A typical rear projection system offering a 55-inch HDTV screen may weigh less than a comparable CRT, but at 200+ pounds it may be difficult and awkward to install and support.

Often, rear projection display devices exhibit average or below average picture quality in certain environments. For example, rear projection displays may be difficult to see when viewed from particular angles within a room setting or when light varies within the environment. Light output and contrast are constant issues in most settings and viewing environments.

Despite advancements in projectors and enhanced lens elements, the lens and reflector design remains generally unchanged and tends to be a limiting factor in both picture quality and overall display system thickness.

A developing variation of rear projection displays utilizes light guides, such as optical fibers, to route an image from an input location to an output location and to magnify the image. Such displays may be referred to as light guide screens (LGSs).

The light guides, commonly glass or acrylic, are typically manufactured as individual fibers or layers of fibers. Typically, the orientation of input light may vary from the required orientation of the output light projected toward an observer. The light guide fibers, therefore, are flexible, and may be bent to accommodate design and manufacturing specifications.

Although flexible, there are limitations on the radius of curvature that may be imposed upon an optical fiber. If bent too sharply, the light may not properly propagate through the fiber. If bent too sharply the fibers may break. Accommodating the necessary radius of curvature for the optical fibers in a light guide screen, may impose limitations upon how thin the screen and the overall enclosing structure may be.

Weight, thickness, durability, cost, aesthetic appearance and quality are key considerations for rear projection display systems and display screens. Further, maintaining a required minimum bend radius for each light guide may be significant. From the manufacturing point of view, cost of production and increased yield are also important.

Hence, there is a need for a rear projection display that overcomes one or more of the drawbacks identified above.

### SUMMARY

This invention provides a light guide screen with louver device. In particular, and by way of example only, according to an embodiment, provided is a light guide screen with louver device including: a plurality of aligned light guides, each light guide having an input end and an output end, the light guides subdivided into an input group and an output group; and a louver device disposed between the input group and the output group, the louver device having a first surface interfacing with the output ends of the input group and a second surface interfacing with the input ends of the output group.

### BRIEF DESCRIPTION OF THE DRAWINGS

FIG. 1 is a schematic diagram of an embodiment of a rear projection display;

FIG. 2 is a plane view of an input group and an output group of a magnifying layer incorporated in the display of FIG. 1;

FIG. 3 is a perspective view of a louver device disposed between a first and a second group of light guides, the light guides arranged into magnifying layers according to an embodiment;

FIG. 4 is a partially exploded, perspective view of the louver device and light guide layers of FIG. 3, the louver device disposed between a first and a second group of light guides, the light guides arranged into magnifying layers according to an embodiment;

FIG. 5 is a partially exploded, perspective view of the louver device of FIGS. 3 and 4, disposed between a first and a second group of light guides according to an embodiment;

FIG. 6 a top view of an input group and an output group of light guides, with a louver device disposed therebetween, according to an embodiment;

FIG. 7 is a cross-sectional view of a single light guide in an input group, a single light guide in an output group, and a louver device disposed therebetween; and

FIG. 8 a top view of an input group and an output group of light guides, with a louver device disposed therebetween, according to an embodiment.

### DETAILED DESCRIPTION

Before proceeding with the detailed description, it is to be appreciated that the present teaching is by way of example, not by limitation. The concepts herein are not limited to use or application with a specific light guide screen with louver device. Thus, although the instrumentalities described herein are for the convenience of explanation, shown and described with respect to exemplary embodiments, it will be appreciated that the principles herein may be equally applied in other types of light guide screen display systems.

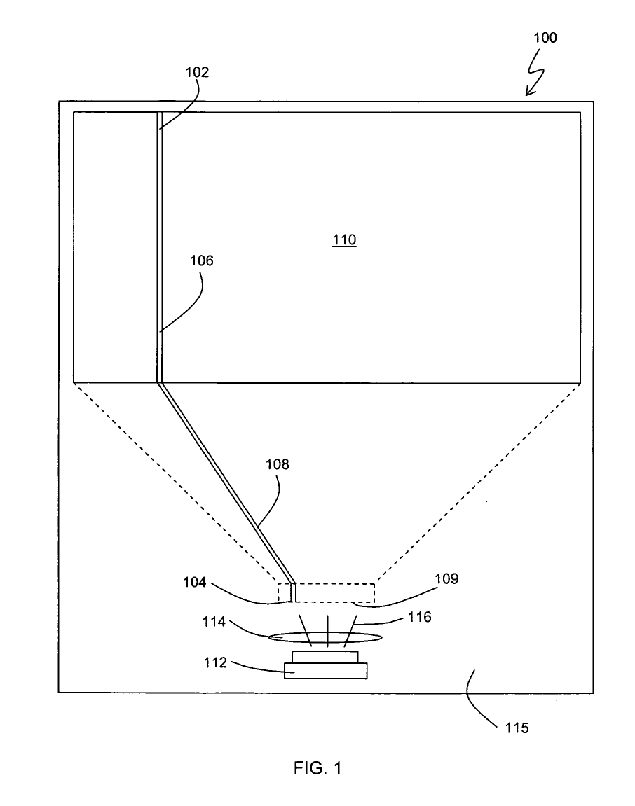

FIG. 1 conceptually illustrates a portion of a light guide screen (LGS) 100. In at least one embodiment, LGS 100 includes a plurality of aligned magnifying layers, of which magnifying layer 102 is exemplary. Each magnifying layer, e.g. layer 102 has an input location or end 104, an output location 106 and a midsection 108. Generally, layer 102 is structured and arranged to enlarge an image provided at input location 104 and present the enlarged image via output location 106. Output location 106 may therefore be referred to as a magnifying output location 106.

Collectively input locations 104 of each layer 102 provide an input face 109. Collectively, output locations 106 of each magnifying layer 102 provide an output face 110. In addition, in at least one embodiment, midsection 108 is a flexible midsection 108.

As shown, each magnifying layer 102 provides one vertical slice of the output face 110. In an alternative embodiment, not shown, each magnifying layer 102 provides one horizontal slice of the output face 110. A light (or image) source 112, is optically coupled to the input end 104. The light (or image) source 112 is positioned proximate to the input face 109. Alternatively an optical system 114 with at least one lens is disposed between the light source 112 and the input face 109. The optical system 114 projects a focused image of the light source 112 onto the input face 109. The output face 110, image source 112, optical system 114, etc. are contained within a case 115. An image 116 provided by light source 112 (such as a projector), and focused by optical system 114 upon input face 109, is conveyed by the light guides of each magnifying layer 102 to the output face 110. In certain embodiments, optical system 114 may be an incorporated part of light source 112.

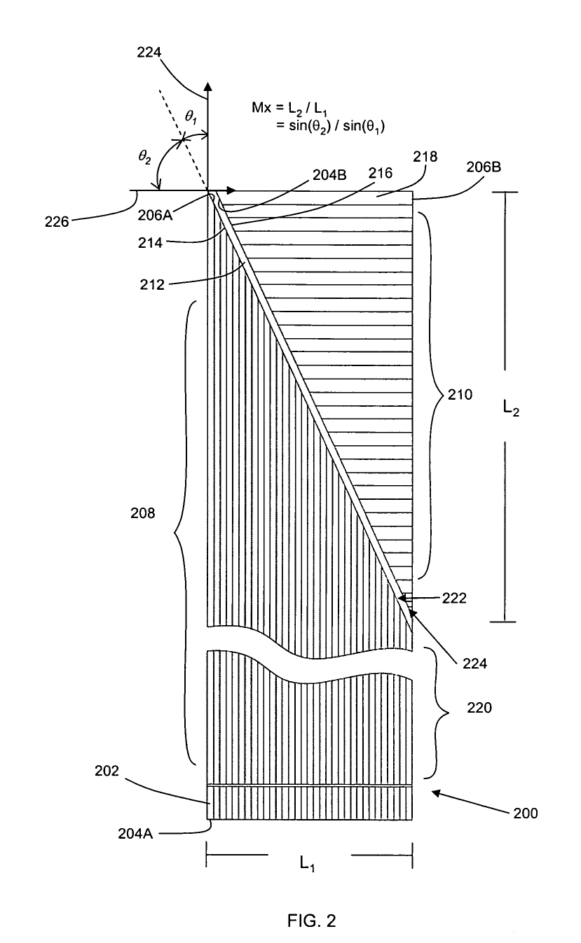

Referring now to FIG. 2, each magnifying layer 102 (FIG. 1) includes a plurality of light guides 200, of which light guide 202 is exemplary. Each light guide has an input end 204 and an output end 206. The light guides are subdivided into an input group 208 and an output group 210. A louver device 212 is disposed between the input group 208 and the output group 210. More specifically, louver device 212 has a first surface 214 interfacing with the output end 206A of light guide 202 in the input group 208. Louver device 212 has a second surface 216 interfacing with an input end 204B of light guide 218 in the output group 210.

It is understood and appreciated that light guides 200 and 210 as used herein may be cladded light guides. More specifically, each light guide, e.g. light guide 202, may consist of a core that is substantially optically clear and a circumferential cladding, as discussed in detail below. The core may have an index of refraction, n₁, and the clad has an index of refraction n₂, wherein n₁>n₂.

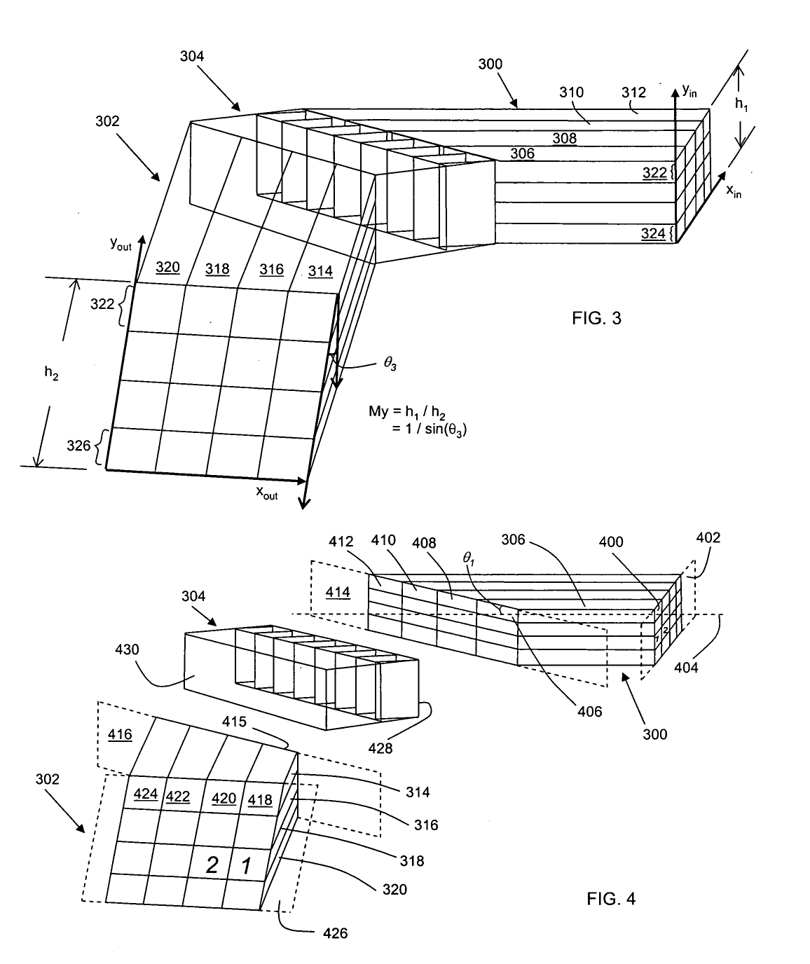

In at least one embodiment, the midsection 220 is a flexible midsection 220. Each magnifying output end 206A is configured to magnify an image presented to the input end 204A. Further, in at least one embodiment, output end 206B is also configured to magnify an image presented to end 204B, as is further described with respect to FIG. 3 below. In at least one embodiment, the plurality of magnifying output ends are aligned in substantially contiguous parallel contact.

More specifically, the magnifying output ends are in substantially contiguous intimate contact, without intervening spacers or material separating each individual output end, e.g. 206A or 206B, from its neighbors on either side. In other words, the magnifying output ends lie next to one another and are in actual contact, touching along their outer surfaces at a point.

Still referring to FIG. 2, a plurality of output ends such as output end 206A, collectively form an output face 222. As shown in FIG. 2, the magnification in this face or plane, Mₓ, equals=sin(θ₂)/sin(θ₁). In this instance, θ₁ may be defined as the angle between a longitudinal centerline of input group 208, represented by arrow 224, and the output face 222 (or input face 224). This angle can be either acute or obtuse. Similarly, θ₂ may be defined as the angle between a longitudinal centerline of output group 210, represented by arrow 226, and output face 222 (or input face 224). As discussed in greater detail below, the magnified image of output face 222 is transmitted to an output surface e.g. output surface 426 in FIG. 4, wherein it may be magnified yet again.

Considering now the structure of light guide screen 100 with louver device in greater detail, FIG. 3 includes an input group 300 and an output group 302 of light guides having a louver device 304 disposed therebetween. In particular, input group 300 includes a plurality of light guides, of which light guides 306, 308, 310 and 312 are exemplary. Further, output group 302 includes a plurality of light guides, e.g. light guides 314, 316, 318 and 320. The light guides 314-320 of output group 302 may be positioned transverse to the light guides 306-312 of input group 300. In particular, in one embodiment, light guides 314-320 are positioned perpendicular to light guides 306-312.

In at least one embodiment, the plurality of light guides of input group 300 and output group 302 are collectively arranged into a plurality of light guide layers, of which light guide layer 322 is exemplary. For example, light guide layer 322 includes light guides 306-312 from input group 300, as well as light guides 314-320 from output group 302. In an alternate embodiment, the plurality of light guides of input group 300 are arranged to form a plurality of light guide layers, such as light guide layer 324. Similarly, the light guides of output group 302 form separate and distinct light guide layers, e.g. light guide layer 326.

In at least one embodiment, each light guide layer, e.g. light guide layer 322, has a thickness equal to approximately the width of one light guide of the input group 300. The width of the light guides in the output group could vary from the same width of the light guides in the input group, up to that width times magnification, Mₓ. As shown in FIG. 3, the collective height of the light guide layers of input group 300 is equal to “h₁”. In at least one embodiment, the individual light guide layers, e.g. layers 322 and 324, have the same height.

Cross-referencing FIGS. 3 and 4, each light guide 306-312 of input group 300 has an input end, for example input end 400 of light guide 306. The collection of input ends define an input plane or input face 402, according to the coordinate system of FIG. 3. As shown, input face 402 is substantially perpendicular to a longitudinal center line 404. Further, as disclosed above, the output ends of each light guide 306-312, e.g. output ends 406, 408, 410 and 412, may be beveled and oriented at an angle “θ₁” relative to center line 404. The output ends 406-412 define an output plane or output face 414. In at least one embodiment, output ends 406-412 may be in contiguous parallel contact. Also, beveled or tapered output ends 406-412 may magnify the imaged received at input face 402.

With regard to output group 302, each light guide 314-320 has an input end 415, the plurality of which collectively define an input plane or input face 416. Input face 416 is oriented toward louver device 304. Cross-referencing for a moment with FIG. 2, it can be appreciated that input face 416 is oriented at an angle “θ₂” relative to a longitudinal centerline of the output group.

Still referring to FIGS. 3 and 4, each light guide 314-320 has a magnifying output end. More specifically, light guides 314, 316, 318 and 320 include magnifying output ends 418, 420, 422 and 424 respectively. The magnifying output ends 418-424 define an output plane or output face 426 which may be beveled relative to the light guide layers 322 and 326 at an angle θ₃ as shown in FIG. 3. Stated differently, output face 426 may slope away from louver device 304 at an angle θ₃ relative to the light guide layers 322 and 326, as shown in FIG. 3 and FIG. 4. In at least one embodiment, magnifying output ends 418-424 may be in contiguous parallel contact. As shown, the angled orientation of faces 414 and 416, combined with beveled output face 426, provide the magnification required (as represented by the numbers “1” and “2” in FIG. 4) as an image is transmitted from input face 402 to output face 426.

The magnification in the y direction is
M_{y}=1/sin(θ₃)

where θ₃ is the bevel angle as shown in FIG. 3.

In practice it is desirable to design the imaging system with isotropic magnification, i.e. the magnification is the same independent of the orientation of an object. Isotropic magnification of the LGS is achieved by making magnification in the x direction, Mₓ, equal to M_{y}.(e.g. Mₓ=M_{y}). This is accomplished by judiciously choosing the angles θ₁, θ₂ and θ₃, such that sin(θ₂)/sin(θ₁).=1/sin(θ₃).

As shown in FIG. 4, louver device 304 is positioned to interface with input group 300 and output group 302. In particular, surface 428 of louver device 304 interfaces with output face 414 of input group 300. Likewise, surface 430 of louver device 304 interfaces with input face 416 of output group 302. Louver device 304 may be joined to each face, i.e. output face 414 and input face 416, by means well known in the art. In one embodiment, louver device 304 is joined to output face 414 and to input face 416 with a substantially boundaryless union at each interface using a glue that has an index of refraction substantially equal to that of the louver device 304 and the core material of the light guides.

In most environments, an observing party will most likely be viewing light emitting from output group 302 from a location substantially perpendicular to the output face 426. The light input to LGS 100, however, may be input along longitudinal centerline 404, which is transverse to the light guides 314-320 of output group 302. To reduce the loss of light, improve the viewing angle provided to an observer, and provide other advantages, louver device 304 is disposed between input group 300 and output group 302, as discussed above. As further described below, louver device 304 receives light at acute angle of incidence and directs the light toward the output face 426 (output face 104 in FIG. 1) at a near normal angle of incidence. In at least one embodiment, a louver film or device, such as that disclosed in U.S. patent application Ser. No. 11/052,605, entitled “Holographic Louver Device for a Light Guide Screen” and incorporated by reference herein, may also be attached to output face 426 to redirect or assist in redirecting the centroid of the output light toward an observer.

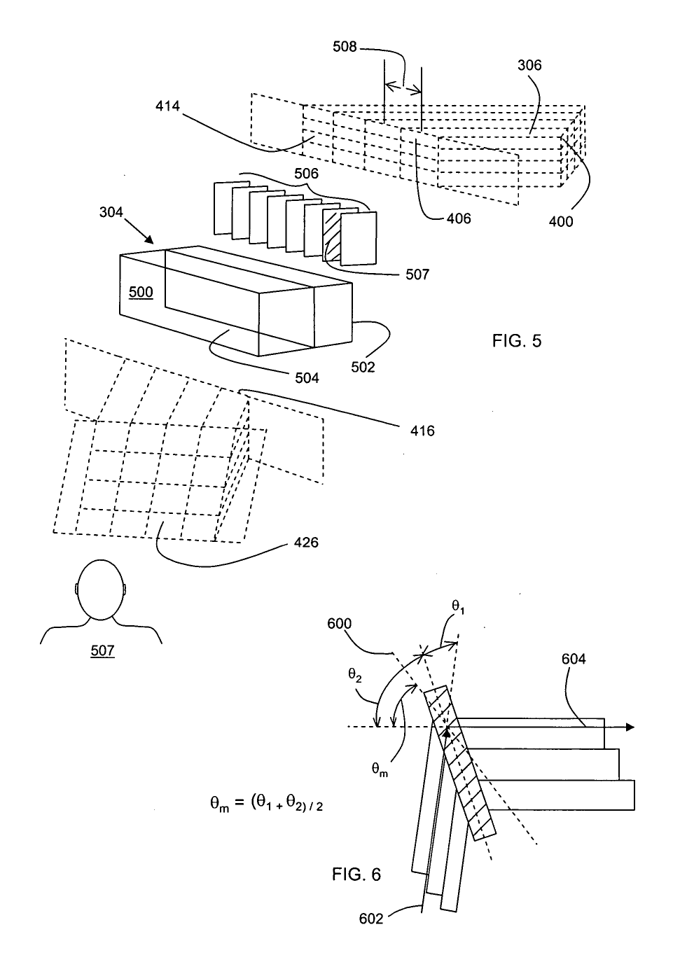

In FIG. 5, an exploded view of louver device 304 is presented. In at least one embodiment, louver device 304 consists of a layer of transparent, optically clear material 500, having an inner surface 502 and, parallel thereto, an outer surface 504. The optically clear layer of material 500 may also be referred to as a sheet of optically clear material. In at least one embodiment, inner surface 502 and outer surface 504 are configured to join to input group 300 and output group 302 respectively, such as by a substantially transparent glue. In yet another embodiment, louver device 304 is configured to removably attach to input group 300 and output group 302, such as by snaps, a tongue-and-groove system, Velcro™, screws, or other such appropriate non-permanent attachment devices.

A plurality of reflective angled surfaces or louver members 506 are disposed at least partially within the assembled louver device 304. In at least one embodiment, louver members 506 are physical reflective surfaces disposed within optically clear layer 500. Further, louver members 506 may be coated with a light-reflective coating 507 to reflect light entering louver device 304. Also, louver members 506 are aligned to at least one predetermined angle. The members 506 may be similarly angled to define a plurality of light paths through transparent layer 500.

In one embodiment of louver device 304, louver members 506 are cylindrical mirror segments. In an alternative embodiment, louver members 506 are elliptical mirror segments. Moreover, the louver members 506 may be elliptical, cylindrical, or may have other geometric shapes. A method of providing such a louver device 304 is described in U.S. patent application Ser. No. 11/052,612 entitled “Method of Making a Louver Device for a Light Guide Screen” which is herein incorporated by reference. In at least one embodiment, louver device 304 incorporates holographic louvers. A holographic louver device is set forth and described in U.S. patent application Ser. No. 11/052,605 incorporated above.

Whether cylindrical, elliptical, or other geometric form, louver members 506 are provided with appropriate focusing power in the horizontal and vertical directions to spread and direct light emerging from output face 414 into input face 416. As substantially all of the light is directed from the light guides, e.g. light guide 306, out through output face 426 towards an observer 507, louver device 304 incorporating louver members 506 advantageously enhances the image quality of LGS 100 and permits a wider range of predetermined viewing angles.

Still referring to FIG. 5, output face 414 comprises a plurality of output ends, e.g. output end 406. The same may be said for input face 416 of output group 302. The output end of each light guide, e.g. output end 406 of light guide 306, may define in part the length, and/or height of the smallest pixel the LGS 100 can display. A pixel is understood to be the smallest complete element of a picture. The cross-sectional view provided in FIG. 5 shows the horizontal width 508, which is the center-to-center spacing of two adjoining output ends. This center-to-center spacing also may define the smallest pixel the LGS 100 can display.

It is understood and appreciated that the term pixel is highly context specific. Further, in certain instances a pixel may be formed from sub-pixel elements, such as red, green and blue elements. A typical standard TV display provides a vertical to horizontal resolution of 640:480 with about 307,200 pixels. A typical HDTV screen provides a vertical to horizontal resolution of 1920:1080 with about 2,116,800 pixels. Although capable of greater resolution a HDTV screen can display a typical TV picture either in a small portion of the usable display or by combining image elements to reduce resolution. With respect to LGS 100, it can be appreciated that a pixel may be defined by several optical fibers or light guides, the output ends of which collectively define the pixel dimensions, or each output end may define a single pixel.

So as to effectively redirect light from output face 414 to input face 416, louver members 506 are aligned to transversely cross output face 414. The optimal angle of the louver is when the line 600 bisecting the angle between the longitudinal center lines 602, 604 of the light guides of the input and output group is perpendicular to the reflectors, as shown in FIG. 6. Under this condition, the angle, θₘ equals (θ₁+θ₂)/2. In the embodiment wherein the light guides are bent, the relationships stated above apply to the straight sections of the light guides immediately adjacent to the louver device 304. Output ends, e.g. output end 406, repeat with periodicity in creating output face 414. The louver members 506 also repeat with periodicity. In at least one embodiment, louver members 506 are spaced at regular intervals and each louver member is substantially identical. In one embodiment, louver members 506 are arranged in parallel rows.

When two periodic structures are close to the same periodicity or simple fractions thereof and disposed proximate to one another, visible fringe patterns may occur. In at least one embodiment, the potential for such fringe patterns on output face 104 (FIG. 1) may be significantly reduced by spacing louver members 506 at intervals about one-third the size of each pixel, which interval is optimal for pixel resolution with reduction in fringing patterns. There is little change if the intervals are smaller. However, as intervals approach one-half or more of the pixel size, fringing patterns may become problematic and resolution can be degraded. In addition, the signal light of one pixel propagated through the light guides of an input group will be coupled to the neighboring pixels of the light guides in the corresponding output group. This causes degradation of the image resolution. In at least one embodiment, the dimensions of the light guides, e.g. light guide 306, are defined to be less than one half of the size of the pixel. Light guides of this magnitude further reduce the fringing pattern on the output face 426 and the cross coupling of the light signal. Moreover, as shown in FIGS. 3, 4 and 5, louver members 506 may be appropriately spaced such that more than one louver member is provided across the length of output end 406.

In at least one embodiment, the index of refraction for optically clear layer 500 will be substantially the same as the index of refraction of the light guide cores establishing the light guide screen. Typically the input group 300 and the output group 302 of the LGS 100 are joined through the louver device 500 via a glue of substantially the same index of refraction. Having substantially the same index of refraction the boundary between the output face 414 and inner surface 502 will not significantly reflect light. Similarly the interface between the outer surface 504 and the input face 416 will not significantly reflect light. In other words, light from a light guide will not be reflected out the back side of light guide 306, i.e. back out through input end 400.

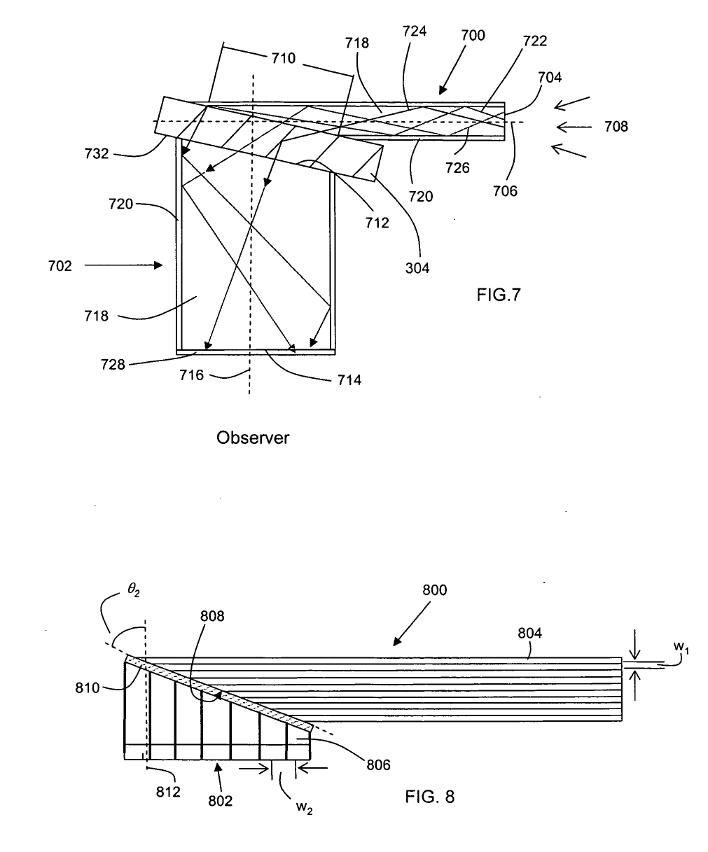

Considering now the transmission of light through LGS 100, with louver device 304, FIG. 7 conceptually illustrates a cross section of a single light guide 700 from an input group, e.g. input group 300 (FIG. 3), a single light guide 702 from an output group, e.g. output group 302 (FIG. 3), and portion of louver device 304 as used in a light guide screen 100. As shown, input end 704 may be substantially transverse to longitudinal centerline 706 for receiving an input image or light 708. Further, output end 710 is at an angle relative to longitudinal centerline 706, as is input end 712. Output end 714, which constitutes a portion of the output face 104 of LGS 100, is substantially transverse to a longitudinal centerline 716.

In at least one embodiment, light 708 is transmitted through light guides which are optical fibers, each having a longitudinal light guide core 718 and an external circumferential cladding 720. It is, of course, realized that light guides 700 and 702 may bend, coil, or otherwise contour such that they may not always lie in a straight line. However, light guides 700 and 702 are shown as straight for ease of discussion and illustration, and as a representation of the preferred embodiment.

In at least one embodiment, light 708 is transmitted through a core 718 formed of a generally optically clear plastic or plastic-type material, including but not limited to a plastic such as acrylic, Plexiglas, polycarbonate material, and combinations thereof. In an alternative embodiment, core 718 is formed of a generally optically clear glass.

Light guides 700, 702 are preferably substantially totally internally reflecting such that the light 708 (further illustrated as lines 722, 724 and 726) received at the input end 704 from image source 112 (FIG. 1) is substantially delivered to the magnifying output end 710 with minimal loss. The same may be said as light rays 722-726 travel from input end 712 to output end 714 and the output face 104 (FIG. 1). Cladding 720 is a material having a refraction index lower then that of core 718. Total internal reflection, or TIR, is the reflection of all incident light off a boundary between cladding 720 and core 718. TIR only occurs when a light ray is both in a medium of higher index of refraction and approaches a medium of lower index of refraction, and the angle of incidence for the light ray is greater than the “critical angle.” In this example, core 718 has a higher index of refraction than cladding 720.

The critical angle is defined as the angle of incidence measured with respect to a line normal to the boundary between the two optical media for which light is refracted at an exit angle of 90 degrees—that is, the light propagates along the boundary—when the light impinges on the boundary from the side of the medium of higher index of refraction. For any angle of incidence greater than the critical angle, the light traveling through the medium with the higher index of refraction will undergo total internal refraction. The value of the critical angle depends upon the combination of materials present on each side of the boundary.

The delivered light 708 emerging from output end 710 passes through a substantially boundaryless interface or union between light guide 700 and louver device 304. The index of refraction of the material of louver device 304 is substantially the same as the index of refraction of core 718, hence little or no light is reflected or refracted as the light passes from light guide 700 to louver device 304. The direction of propagation will, therefore, be substantially in line with longitudinal centerline 706 and will have an annular field of view, θᵢ, substantially defined by the equation nᵢ sin(θᵢ)=nₒ sin(θₒ). Wherein θₒ is the angle of acceptance of the light guide 700 and nᵢ is the index of refraction of the core of the light guides. Of note, nₒ is the index of refraction of the medium from where the image light impinges up the light guide. This medium is usually air or vacuum and nₒ is substantially equal to 1. In at least one embodiment, the light emerges from the output end 714 into the same medium nₒ, and the divergence angle is substantially the same as the acceptance angle θₒ. The output end 714 is usually beveled, as depicted in FIG. 4. In particular the beveled output ends 418-424 form a portion of the beveled output face 426. In some instances, this may be an angular field of view that is both smaller than desired and oriented away from a normal viewing location.

To improve the viewing angle provided to an observer, and provide other advantages, a louver device 728 may be disposed on the output face defined by the output ends, e.g. output end 714. This louver device 728 receives light from light guide 702 at acute angle of incidence to the output face and directs the light such that it emerges from the output end 714 of light guide 702 with an output cone centered at a near normal angle of exit. The exit cone angles are further customized as described in U.S. patent application to ______, Ser. No. ______, filed ______, titled “Louver Device for a Light Guide Screen” and incorporated by reference herein.

As shown in FIG. 8, the size or width (center-to-center spacing) of input group 800 may be smaller than the center-to-center spacing of output group 802. More specifically, the center-to-center spacing, “w₁”, of pixels defined by input light guides, e.g. light guide 804 may be smaller than the center-to-center spacing, “w₂”, of pixels defined by output light guides, e.g. light guide 806. This may be necessitated, in part, by the magnitude of angle “θ₂”, i.e. the acute angle of output face 808 (FIG. 4) and louver device 810 relative to longitudinal centerline 812. Moreover, the number of input group 800 light guides may not be equal to the number of output group 802 light guides. For example, in FIG. 8, ten (10) input light guides feed into 20 output light guides, through louver device 304.

In at least one alternative embodiment, the number of the light guides in the input group 800 and the output group 802 is the same (as is shown in FIG. 2 for input group 208 and output group 210). So as to accommodate the beveled output ends of the input group 802, the width of the output group is selected to be larger. In an embodiment where there is a one to one relationship between the light guides of the input group 800 and the out put group 802, each single input end of input group 800 may correspond to a single image pixel observed by an observer viewing the collective output ends of output group 802. In an embodiment where there is a greater number of input group 800 light guides when compared to output group 802 light guides, generally multiple input ends will correspond to a single image pixel.

A benefit of employing a louver device 810 to redirect input images or light is clearly represented in FIG. 8. With a louver device 810 positioned between input group 800 and output group 802, it is possible to “bend” or redirect light transverse to the orientation of the input light guides, without having to physically bend the light guides. The radius of the bend is usually made to be at least ten times bigger than the cross sectional dimension of the light guide. The output light guides are transverse to the input light guides, and may be normal thereto. In this manner, a LGS 100 with a reduced through-thickness may be manufactured.

Changes may be made in the above methods, systems and structures without departing from the scope thereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A light guide screen with louver device comprising:
a plurality of aligned light guides, each light guide having an input end and an output end, the light guides subdivided into an input group and an output group; and
a louver device disposed between the input group and the output group, the louver device having a first surface interfacing with the output ends of the input group and a second surface interfacing with the input ends of the output group.

2. The light guide screen of claim 1, wherein the output group is oriented transverse to the input group.

3. The light guide screen of claim 1, wherein the input group and output group are structured and arranged to magnify an image provided to the input ends of the input group as delivered to the output ends of the output group.

4. The light guide screen of claim 1, wherein the louver device is joined to the output ends of the input group with a substantially boundaryless union, and joined to the input ends of the output group with a substantially boundaryless union.

5. The light guide screen of claim 1, wherein the number of input group light guides is not equal to the number of output group light guides.

6. The light guide screen of claim 1, wherein the number of input group light guides is equal to the number of output group light guides.

7. The light guide screen of claim 1, wherein the plurality of light guides are arranged into a plurality of light guide layers, each layer one light guide thick, each layer including light guide members of the input group and light guide members of the output group.

8. The light guide screen of claim 7, wherein the output ends of the input group of a light guide layer are in substantially contiguous parallel contact.

9. The light guide screen of claim 7, wherein the output ends of the output group of a light guide layer are in substantially contiguous parallel contact.

10. The light guide screen of claim 7, wherein the input group of light guides has a collective width, the light guide layer having substantially the same width.

11. A light guide screen with louver device comprising:
a first plurality of light guides, each light guide having an input end and a corresponding output end, the plurality of input ends arranged in layers to form a first input face, and the plurality of corresponding output ends arranged in layers to form a first output face;
a second plurality of light guides, each light guide having an input end and a corresponding output end, the plurality of input ends arranged in layers to form a second input face, and the plurality of output ends arranged in layers to form a second output face; and
a louver device for redirecting light from the first plurality of light guides to the second plurality of light guides, the louver device having a first surface interfacing with the first output face, and a second surface interfacing with the second input face.

12. The light guide screen of claim 11, wherein the louver device is joined to the first output face and to the second input face with a substantially boundaryless union at each interface.

13. The light guide screen of claim 11, wherein the number of first plurality light guides is not equal to the number of second plurality light guides.

14. The light guide screen of claim 11, wherein the number of first plurality light guides is equal to the number of second plurality light guides.

15. The light guide screen of claim 11, wherein the second plurality of light guides is oriented at a transverse angle relative to the first plurality of light guides.

16. The light guide screen of claim 11, wherein the second plurality of light guides is oriented at a substantially 90 degree angle relative to the first plurality of light guides.

17. The light guide screen of claim 11, wherein the louver device comprises:
a transparent layer;
a plurality of similarly angled surfaces defining a plurality of light paths through the transparent layer; and
a light-reflective coating on each angled surface to reflect light entering the louver from the first plurality of light guides.

18. The light guide screen of claim 17, wherein the first output face comprises a plurality of pixels, and wherein each angled surface of the louver device is positioned at a spacing interval not greater than one half the size of each pixel.

19. A method of making a light guide screen with louver device comprising:
providing a first plurality of light guides, each light guide having an input end and a corresponding output end, the plurality of input ends arranged in layers to form a first input face, and the plurality of corresponding output ends arranged in layers to form a first output face;
providing a second plurality of light guides, each light guide having an input end and a corresponding output end, the plurality of input ends arranged in layers to form a second input face, and the plurality of output ends arranged in layers to form a second output face; and
positioning a louver device between the first output face and the second input face to redirect light from the first plurality of light guides to the second plurality of light guides, the louver device having a first surface interfacing with the first output face, and a second surface interfacing with the second input face.

20. The method of claim 19, further comprising joining the louver device to the first output face and to the second input face with a substantially boundaryless union at each interface.

21. The method of claim 19, further comprising orienting the second plurality of light guides at a substantially 90 degree angle relative to the first plurality of light guides.

22. The method of claim 19, wherein the louver device comprises:
a transparent layer;
a plurality of similarly angled surfaces defining a plurality of light paths through the transparent layer; and
a light-reflective coating on each angled surface to reflect light entering the louver from the first plurality of light guides.

23. The method of claim 22, wherein the first output face comprises a plurality of pixels, and further wherein each angled surface of the louver device is positioned at a spacing interval not greater than one half the size of each pixel.

24. A light guide screen with louver device comprising:
a means for grouping a plurality of output ends of a first plurality of light guides into layers to form a first output face;
a means for grouping a plurality of input ends of a second plurality of light guides into layers to form an input face;
a means for grouping a plurality of output ends of the second plurality of light guides into layers to form a second output face; and
a means for redirecting light from the first output face of the first plurality of light guides into the input face of the second plurality of light guides and towards the second output face.

25. The light guide screen of claim 24, wherein the means for redirecting the light toward the second output face is a louver device.

26. The light guide screen of claim 24, wherein the second plurality of light guides is oriented at a substantially 90 degree angle relative to the first plurality of light guides.

27. The light guide screen of claim 25, wherein the louver device comprises:
a transparent layer;
a plurality of similarly angled surfaces defining a plurality of light paths through the transparent layer; and
a light-reflective coating on each angled surface to reflect light entering the louver from the first plurality of light guides.

28. The light guide screen of claim 27, wherein the first output face comprises a plurality of pixels, and further wherein each angled surface of the louver device is positioned at a spacing interval not greater than one half the size of each pixel.

29. A light guide screen with louver device comprising:
a case;
a first plurality of light guides, each light guide having an input end and a corresponding output end, the plurality of input ends arranged in layers to form a first input face, and the plurality of corresponding output ends arranged in layers to form a first output face;
a second plurality of light guides, each light guide having an input end and a corresponding output end, the plurality of input ends arranged in layers to form a second input face, and the plurality of output ends arranged in layers to form a second output face;
a louver device for redirecting light from the first plurality of light guides to the second plurality of light guides, the louver device having a first surface interfacing with the first output face, and a second surface interfacing with the second input face; and
at least one image source proximate to the first input face.

30. The light guide screen of claim 29, wherein the louver device is joined to the first output face and to the second input face with a substantially boundaryless union at each interface.

31. The light guide screen of claim 29, wherein the second plurality of light guides is oriented at a 90 degree angle relative to the first plurality of light guides.

32. The light guide screen of claim 29, wherein the louver device comprises:
a transparent layer;
a plurality of similarly angled surfaces defining a plurality of light paths through the transparent layer; and
a light-reflective coating on each angled surface to reflect light entering the louver from the first plurality of light guides.

33. The light guide screen of claim 32, wherein the first output face comprises a plurality of pixels, and wherein each angled surface of the louver device is positioned at a spacing interval not greater than one half the size of each pixel.
